(19) United States
(12) Patent Application Publication
(10) Pub. No.: US 2011/0220471 A1
(43) Pub. Date: Sep. 15, 2011

(54) Micromechanical component and method for manufacturing a micromechanical component

(76) Inventors: Hubert Benzel, Pliezhausen (DE); Christoph Schelling, Stuttgart (DE)

(21) Appl. No.: 12/932,992

(22) Filed: Mar. 11, 2011

(30) Foreign Application Priority Data
Mar. 12, 2010 (DE) 10 2010 002 818.5

(51) Int. Cl. H01H 59/00; H01H 11/00

(52) U.S. Cl. 200/181; 29/622

(57) ABSTRACT

A micromechanical component, e.g., a switch, includes a substrate having at least one recess, at least two electrically conductive contact surfaces provided in the region of the recess, and an actuator. The contact surfaces are able to be brought into contact with one another for electrical conduction with the aid of the actuator.

### BACKGROUND OF THE INVENTION

1. Field of the Invention

The present invention relates to a micromechanical component, in particular a switch, and a corresponding manufacturing method for a micromechanical component.

2. Description of the Related Art

Although applicable to any given micromechanical components, the present invention and its underlying background are explained with regard to micromechanical components using silicon technology.

A method and a device for determining material data of microstructures are known from published German patent application document DE 199 19 030 A1. The device includes a substrate, and provided with the substrate is at least one bending element which is anchored on one side, situated at a distance from the substrate, at least in places, and made of the material to be tested. The length of the bending element is less than 2 mm. Means are also provided via which the bending element is movable from its starting position.

A sensor in particular for measuring the viscosity and density of a medium is known from published German patent application document DE 198 04 326 A1. The sensor includes a bending tongue and a piezoelectric oscillator. The bending tongue may be induced to oscillate in a measuring medium by excitation by the piezoelectric oscillator. The oscillation frequency and the damping of the bending tongue are a function of the density, i.e., the viscosity, of the measuring medium.

A pressure sensor based on the piezoresistive converter principle and a method for manufacturing same are known from published international patent application document WO 02/02458, published German patent application document DE 10 2004 036032 A1, and published German patent application document DE 10 2004 036035 A1. This manufacturing method is summed up under the term “advanced porous silicon membrane” (APSM for short).

In addition, a manufacturing method for applying micromechanical structures is known from another reference. A thin, light-absorbing layer is applied to the back side of a substrate and is protected by a transparent layer. As a result of irradiating the transparent layer with a brief laser pulse, the material of the light-absorbing layer evaporates in an explosive manner in the region of an incidence surface of the laser pulse. This causes generation of an acoustic shock wave which passes through the substrate. If the substrate is structured, structures in the substrate may thus be destroyed in a targeted manner. A recess situated between the substrate and the transparent layer results at the location of the evaporated material.

### BRIEF SUMMARY OF THE INVENTION

The micromechanical component and the method for manufacturing a micromechanical component according to the present invention have the advantages that a low-resistance contact is possible as a result of the direct contacting of the two contact surfaces. Lastly, the micromechanical component on the one hand may be manufactured very economically, and on the other hand is very small and may be used on a chip. The micromechanical component may therefore likewise be easily embedded in an integrated circuit on a carrier chip.

According to one preferred refinement, the contact surfaces are essentially completely galvanically separated. The advantage is that the micromechanical component may also be used for applications which require complete galvanic separation, for example for a voltage supply for measuring devices for potential separation, etc.

According to one preferred refinement, the contact surfaces each include at least one metal layer. The advantage is that a very low-resistance contact is made possible by direct contacting of metallic conductors when the contact surfaces are brought into contact with one another with the aid of the actuator. When the metal layer includes in particular gold, platinum, silver, palladium, tungsten, copper, and/or chromium, or the like, it is advantageous that these metals on the one hand may be easily applied, and on the other hand have good conductivity.

An oxide layer may be provided between the substrate and the metal layer. The advantage is that the oxide layer may be applied to the substrate in a simple and cost-effective manner using known methods such as PECVD, for example. The oxide layer ensures that the metal layer is sufficiently insulated from the substrate.

According to another preferred refinement, the actuator includes at least two electrodes, between which in particular a piezoelectric layer is situated. The advantage is that a compact design and a short switching time of the micromechanical component are thus achieved. The actuator may also include electrostatic, inductive, and/or thermal means in addition to the piezoelectric means. The advantage is that the component may thus be used in a variety of fields or adapted to various requirements. If, for example, the actuator is actively operated, i.e., the actuator presses the two contact surfaces together, this may be achieved by applying an appropriate voltage to the actuator, whereas for passive operation of the component the actuator may be indirectly activated by thermal means, for example, in that the actuator is deformed by heat, and the two contact surfaces are thus pressed together or moved apart.

According to another preferred refinement, the recess is situated between a bar, which in particular is connected as one piece to the substrate, and the substrate. The advantage is that simple, cost-effective manufacture of the micromechanical component is made possible.

According to another preferred refinement, the actuator is situated on an outer side of the micromechanical component, in particular of the bar. The advantage is that on the one hand good accessibility of the actuator is ensured in order to connect it to a current source or a voltage source, for example, and on the other hand the actuator may be provided on the outer side in a particularly simple manner.

According to another preferred refinement, the actuator is situated in the region of the recess, in particular in the region of the bar. The advantage is that the actuator thus brings the contact surfaces in contact with one another in the most direct manner possible. When the actuator is situated in particular in the region of the bar, in addition to further improved activation of the two contact surfaces easy accessibility of the actuator is also made possible.

According to one preferred refinement of the method, producing the recess includes the steps of producing at least one cavity, in particular with the aid of APSM, and partially opening the produced cavity for forming a recess. The advantage is that very small cavities and thus also very small structures of the component may thus be reliably produced or provided. The opening of the cavity may include an etching step. The advantage is that flat flanks result during the etching, on which a layer to be subsequently deposited, in particular a sputtered layer, may be applied in an improved manner.

To allow reliable insulation of the metal layer from the substrate, an oxide layer may be applied to the surface of the substrate before applying the metal layer. To apply a contact layer to the metal layer in a particularly simple and cost-effective manner, the contact layer may be applied to the in particular structured metal layer by electroplating.

According to another preferred refinement, two cavities are produced, and a connection is established between the recess and a cavity, in particular by laser spallation. The advantage is that by establishing a connection between a recess and the cavity, an in particular galvanic separation of the contact layer into at least two parts is easily achieved.

According to another preferred refinement, at least one laser-absorbing layer is applied to a surface of the substrate, the absorbing layer in particular being situated at a distance from the region of the recess. The advantage is that it is therefore not necessary to temporarily provide the region of the recess with an additional layer. The complexity and thus also the costs of manufacturing the micromechanical component are reduced.

When the laser spallation is used for at least partially indirectly destroying the structure of the substrate, the advantage is that the destruction of the structure is simplified, since the structure is usually directly accessible only with great difficulty. Thus, at the same time the likelihood of damaging the region of the recess is reduced.

### BRIEF DESCRIPTION OF THE DRAWINGS

FIGS. 1 and 2 show two cross-sectional views of a micromechanical component according to a first specific embodiment of the present invention.

FIGS. 3a and 3b show a micromechanical component according to the first specific embodiment when the actuator is activated.

FIGS. 4a-4e show steps for manufacturing a micromechanical component according to a first specific embodiment, with the micromechanical component in a top view.

FIGS. 5a-5f show steps for manufacturing a micromechanical component according to a second specific embodiment, with the micromechanical component illustrated in cross section or in a top view (FIG. 5e).

### DETAILED DESCRIPTION OF THE INVENTION

In the figures, identical or functionally equivalent elements are denoted by the same reference numeral.

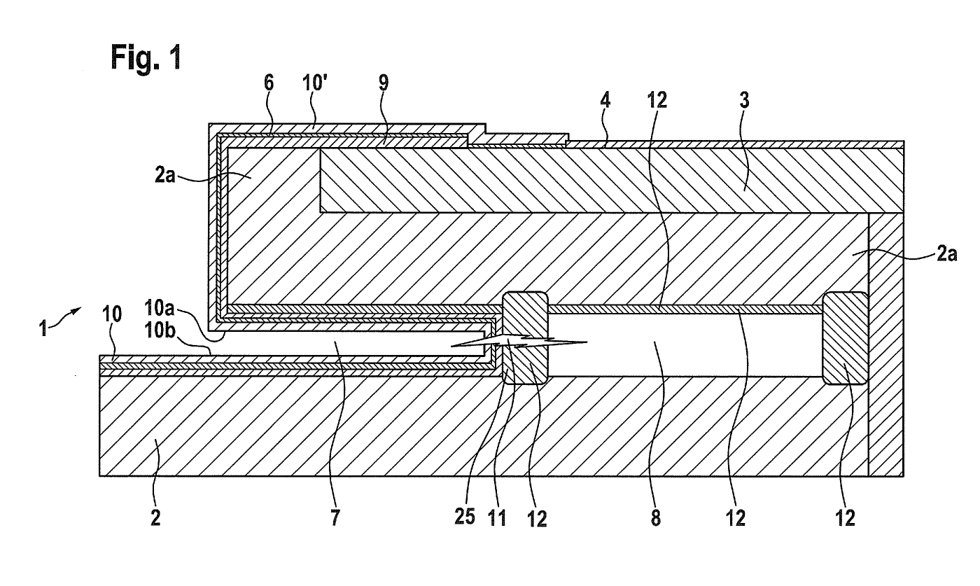

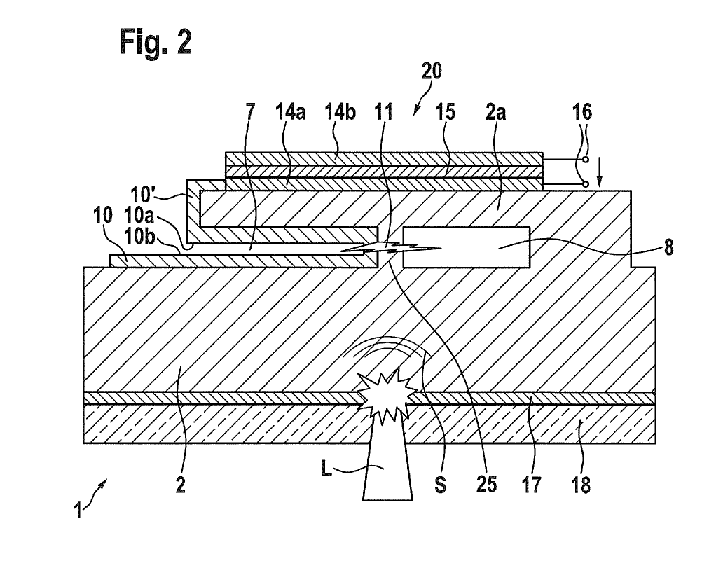

FIG. 1 and FIG. 2 show a micromechanical component according to a first specific embodiment of the present invention, illustrated schematically in cross section.

In FIG. 1, reference numeral 1 denotes a micromechanical component in the form of a switch. The switch includes a substrate 2. A portion of the substrate is designed as a rectangular bar 2a which is connected in one piece to substrate 2. A cavity 8 and a recess 7 are situated between bar 2a and substrate 2. An actuator is also provided (see FIG. 2). The end of bar 2a which is not connected in one piece to substrate 2 as well as the substrate 2 itself include on their respective outer sides, from the inside to the outside, an oxide layer 9 for electrical insulation, a bond pad layer 6 for easier application of a metal layer 10, and a metal layer 10, 10′. Metal layer 10′, which is situated on bar 2a and which is located adjacent to and at a distance from metal layer 10 of substrate 2a via recess 7, is galvanically divided into two parts by a connecting element 25 between substrate 2 and bar 2a which is destroyed by laser spallation L, forming a gap 11. When bar 2a is then pushed downward at its left end as shown in FIG. 1, two metallic contact surfaces 10a, 10b of metal layer 10, 10′ (with one contact surface situated on substrate 2 and the other contact surface situated on bar 2a) are pressed together in the region of recess 7, thus making electrical contact possible. When bar 2a is no longer pushed downward, i.e., the bar bends upward according to FIG. 1 or moves back to a neutral position, contact surfaces 10a, 10b no longer contact one another; i.e., an electrically conductive connection no longer exists between metal layers 10, 10′ of bar 2a and of substrate 2. Delimiting layers 12 are also appropriately provided in cavity 8 in order to produce cavity 8 with the aid of APSM.

FIG. 2 essentially shows a simplified illustration of a device 1 according to FIG. 1, illustrated schematically in cross section, during production of gap 11, and having an actuator 20.

An absorbing layer 17 and a transparent layer 18 thereupon are situated on the bottom side of substrate 2 according to FIG. 2. When a laser beam L initially strikes transparent layer 18, the laser beam passes through transparent layer 18. When laser beam L subsequently strikes absorbing layer 17, the material of absorbing layer 17 evaporates in an explosive manner in the region of laser beam L, and generates an acoustic shock wave S which passes through substrate 2. When this shock wave strikes the region between recess 7 and cavity 8 of substrate 2, more specifically, strikes connecting element 25, shock wave S destroys connecting element 25, resulting in a gap 11 which thus divides metal layers 10, 10′ into two parts which are electrically insulated and galvanically separated from one another.

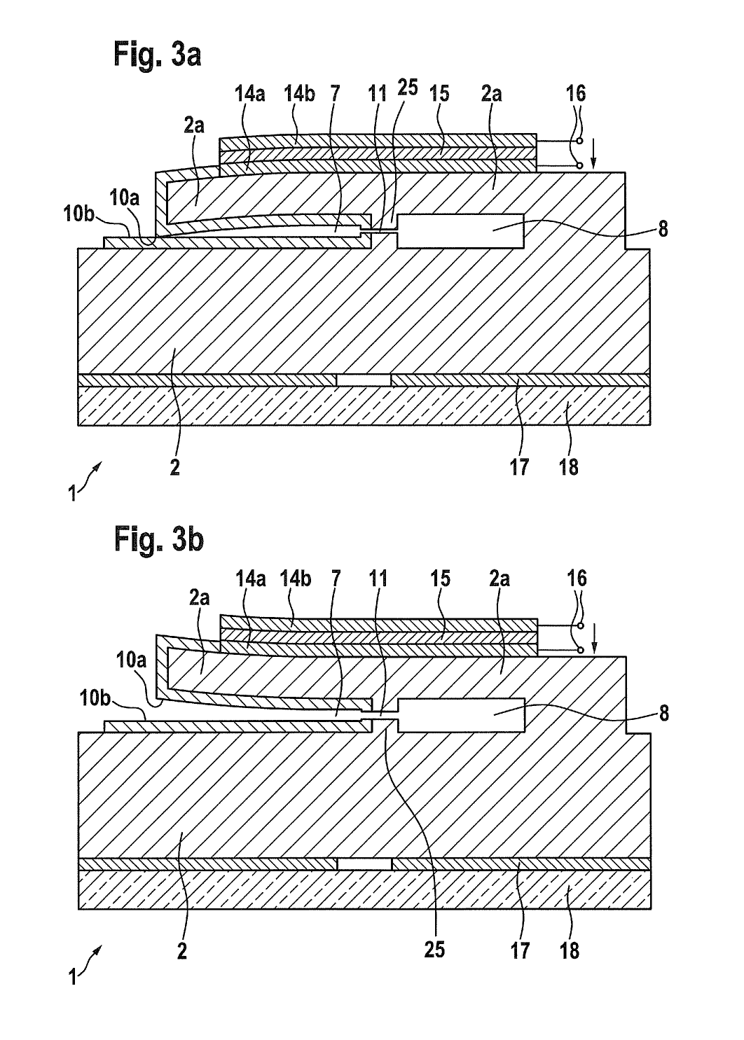

FIGS. 3a, b show micromechanical components according to the first specific embodiment when the actuator is activated.

According to FIGS. 3a, 3b, an actuator 20 is situated on an outer side of bar 2a, i.e., on the side facing away from recess 7, and includes two electrodes 14a and 14b. A piezoelectric layer 15 is situated between electrodes 14a, 14b. The two electrodes 14a, 14b are provided with terminals 16 to which a voltage U may be applied. When voltage U is now applied between terminals 16, bar 2a together with its contact surface 10a is pushed downward by actuator 20, in the form of piezoelectric element 14a, 14b, 15 in FIG. 3a, until the two contact surfaces 10a, 10b at least partially contact one another. A conductive connection is thus established between contact surfaces 10a, 10b. When an appropriate voltage −U is applied to terminals 16 of actuator 20, according to FIG. 3b bar 2a is moved upward by actuator 20. The two contact surfaces 10a, 10b separate from one another, and therefore there is no longer a conductive connection between contact surfaces 10a, 10b of substrate 2 and bar 2a.

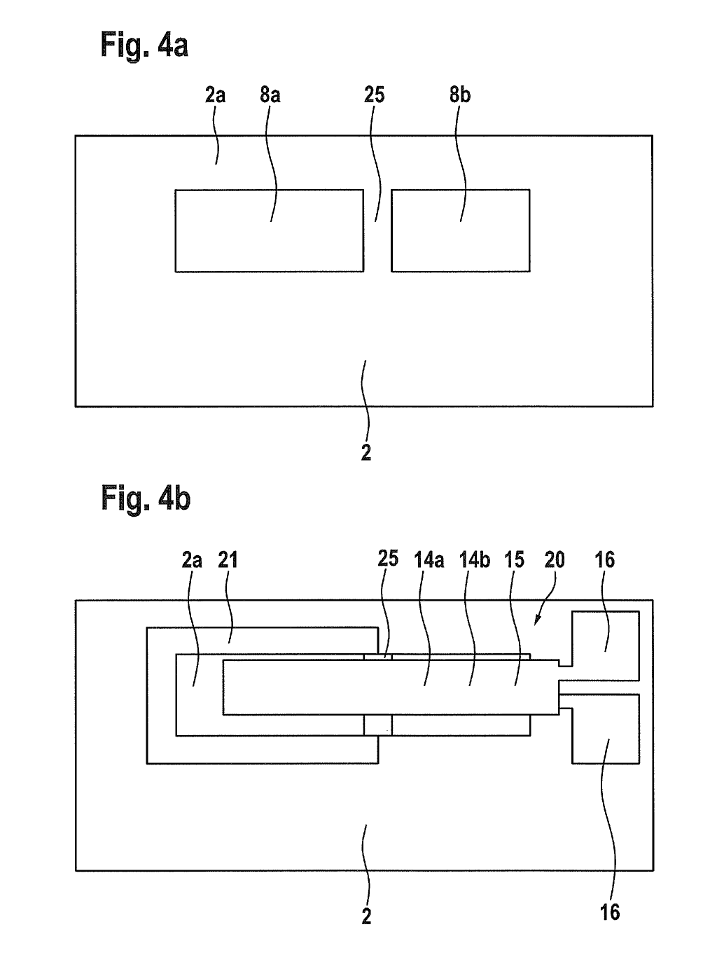

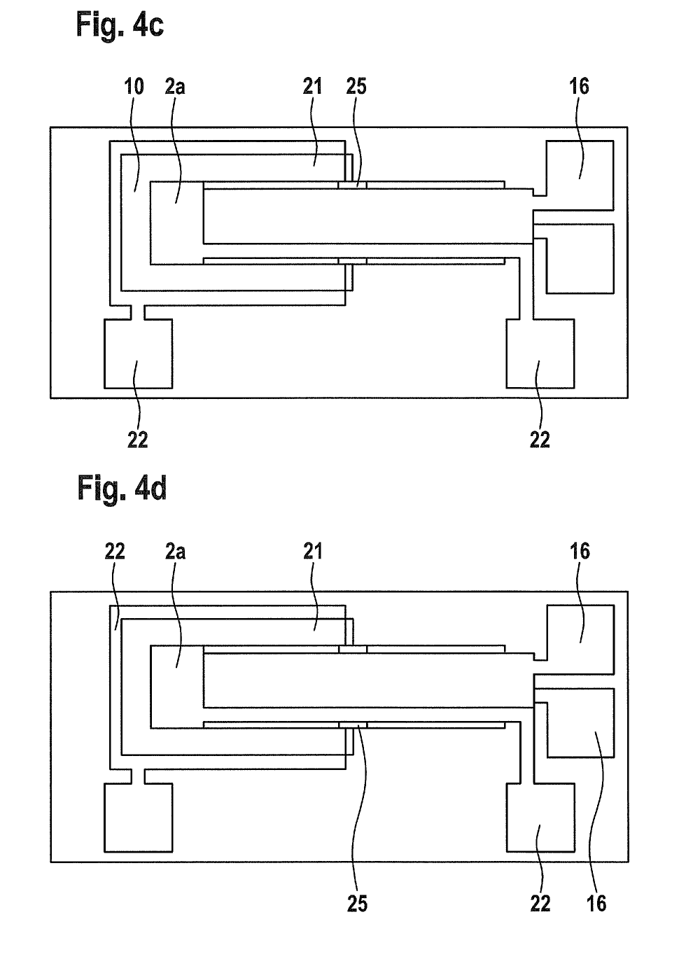

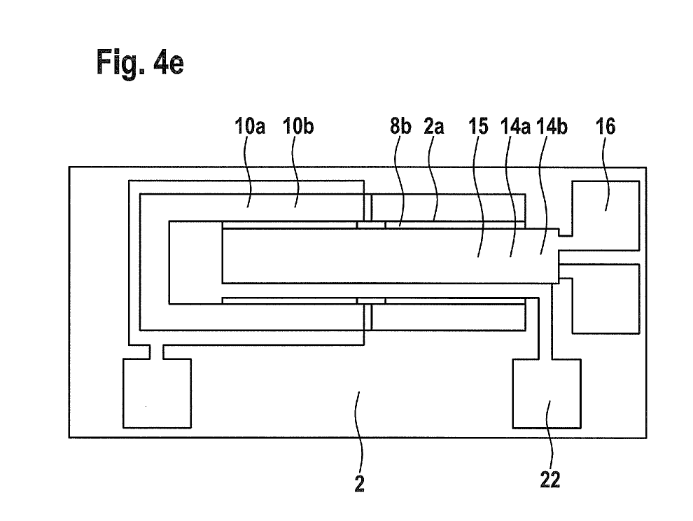

FIGS. 4a-e show steps for manufacturing a micromechanical component according to a first specific embodiment, with the micromechanical component in a top view.

In FIG. 4a, two cavities 8a, 8b are initially provided in a substrate 2 with the aid of an APSM process, the cavities being separated from one another by a connecting element 25.

According to FIG. 4b, an actuator 20 is subsequently applied in the form of a first electrode 14a, a piezoelectric layer 15, and a second electrode 14b, and is provided with terminals 16. Using a trench technique, a section 21 in the region of bar 2a is exposed, and an oxide layer 9 is subsequently applied to substrate 2 and to bar 2a. According to FIG. 4c, in a further step a bond pad layer and/or printed conductors in the form of a metal layer 6 is/are applied to substrate 2 and bar 2a, which are provided with terminals 22 and structured. In the next step according to FIG. 4d, a contact layer 10, in particular a gold layer, is applied to metal layer 6 by electroplating. Contact layer 10 grows only in locations where metal layer 6 has been applied, in particular also on the sides of substrate 2 or bar 2a which border recess 7. According to FIG. 4e, the region of bar 2a which has not yet been exposed is then exposed using the trench technique, so that the entire bar 2a is then exposed. In a last step, laser spallation (see FIG. 1) is used to produce a gap 11 between cavity 8b and recess 7 by destroying connecting element 25 between the two cavities 8a, 8b.

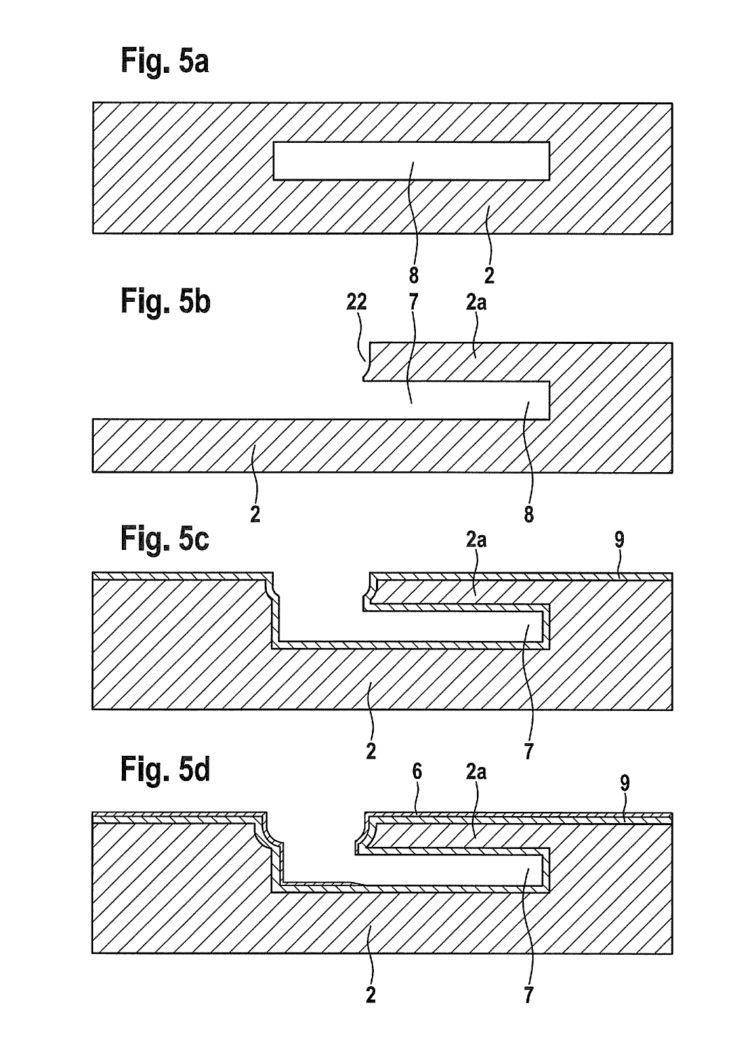

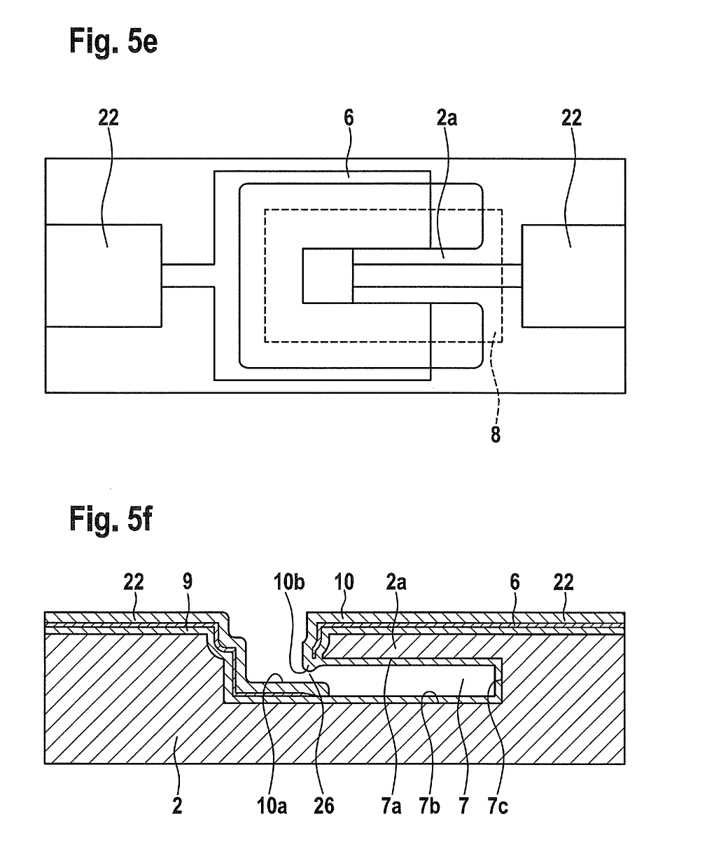

FIGS. 5a-f show steps for manufacturing a micromechanical component according to a second specific embodiment, with the micromechanical component illustrated in cross section and in a top view (FIG. 5e).

FIG. 5a shows a cavity 8 in a substrate 2 which has been produced with the aid of an APSM process. An actuator (not shown) is then provided in the region of cavity 8 on an outer side of cavity 8. In a subsequent step, according to FIG. 5b a portion of substrate 2 is removed in the region of cavity 8 by etching 22, so that a bar 2a which is connected on one side to substrate 2 is produced, and a recess 7 is provided between bar 2a and substrate 2. In a subsequent step according to FIG. 5c an oxide layer 9, in particular deposited TEOS oxide, for example, is applied to the surface of substrate 2 and bar 2a. The surfaces of substrate 2 and bar 2a are each provided with oxide layer 9 in the region of recess 7. In a further step according to FIG. 5d a metal coating 6 is applied by sputtering, for example. This metal layer 6 is applied only in regions which are directly accessible from above according to FIG. 5d; i.e., the metal coating is not provided in an inner region of recess 7; i.e., sides 7a, 7b, 7c bordering recess 7 are not provided with metal layer 6.

This metal layer 6 is used as a starting layer for electroplating of a contact layer or metal layer 10, 10′ according to FIG. 5e, and is structured, preferably using a plasma etching process. In a further step according to FIG. 5e, in the region of the transition between bar 2a and substrate 2 the metal of starting layer 6 is removed or structured away, for example using a spray paint process.

FIG. 5f shows the micromechanical switch thus produced, in the cross section, after a contact layer 10 composed of chromium, nickel, gold, or the like, has been galvanically deposited on metal layer 6 by electroplating. Galvanically deposited contact layer 10 grows only on the metal-plated regions of metal layer 6. No contact layer 10 is grown or deposited in the region of recess 7, in particular sides 7a, 7b, 7c. No metal layer 6 has been deposited at that location, since these sides were not accessible from above according to FIG. 5d. Contact surface 10 is therefore divided into two sections 10a, 10b. These sections are electrically insulated from one another. As a result of galvanically deposited contact layer 10, which has the property in particular that it grows on metal layer 6 in all directions, an overlap area 26 results via which the two contact surfaces 10a, 10b may be brought in contact with one another to allow a reliable electrical connection to be established when bar 2a is moved toward substrate 2. In addition, an actuator 20 having a piezoelectric drive may likewise be situated in the region of bar 2a. This piezoelectric drive is then able to directly move contact surface 10b of bar 2a onto contact surface 10a of substrate 2, so that contact surfaces 10a, 10b make electrically conductive contact with one another.

Although the present invention has been described above on the basis of preferred exemplary embodiments, it is not limited thereto, and is modifiable in numerous ways; in particular, further contacts having actuators may be provided, as well as one or multiple integrated circuits for control, for example.

What is claimed is:

1. A micromechanical component configured as a switch, comprising:
a substrate having at least one recess, wherein at least two electrically conductive contact surfaces are provided in the region of the recess; and
an actuator configured to selectively bring the contact surfaces into contact with one another for electrical conduction.

2. The micromechanical component as recited in claim 1, wherein the contact surfaces are essentially completely galvanically separated.

3. The micromechanical component as recited in claim 2, wherein the contact surfaces each include at least one metal layer having at least one of gold, platinum, silver, palladium, tungsten, copper, and chromium.

4. The micromechanical component as recited in claim 1, wherein the actuator includes at least two electrodes and a piezoelectric layer situated between the at least two electrodes.

5. The micromechanical component as recited in claim 1, wherein the recess is situated between a bar and the substrate, the bar being connected to the substrate.

6. The micromechanical component as recited in claim 5, wherein the actuator is situated in the region of the bar.

7. The micromechanical component as recited in claim 5, wherein the actuator is situated on an outer side of the bar.

8. A method for manufacturing a micromechanical component, comprising:
producing at least one recess in a substrate;
applying an actuator in the region of the recess; and
applying and structuring a metal layer on the substrate in the region of the recess.

9. The method as recited in claim 8, wherein the step of producing the recess includes producing at least one cavity and partially opening the produced cavity to form the recess.

10. The method as recited in claim 8, further comprising:
producing two cavities; and
providing an open connection between the recess and one of the two cavities by laser spallation.

11. The method as recited in claim 8, further comprising:
applying at least one laser-absorbing layer to a surface of the substrate situated at a distance from the region of the recess.
